(19) United States
(12) Patent Application Publication
(10) Pub. No.: US 2003/0064087 A1
(43) Pub. Date: Apr. 3, 2003

(54) Rodent repellant composition and a process for the preparation thereof

(76) Inventors: Mohammad Qamar Parwez, Delhi (IN); Mozaffar Alam Khan, Gaya (IN); Shivani Singh, New Delhi (IN)

Correspondence Address: VENABLE, BAETJER, HOWARD AND CIVILETTI, LLP, P.O. BOX 34385, WASHINGTON, DC, 20043-9998, US

(21) Appl. No.: 09/969,128

(22) Filed: Oct. 3, 2001

(51) Int. Cl. A01N 25/08

(52) U.S. Cl. 424/409

(57) ABSTRACT

This invention relates to a rodent repellant composition having 5-50% ethylene vinyl acetate by weight of low density polyethylene, 0.25-10% rodent repellent material by weight of low density polyethylene and the remainder being low density polyethylene mixed together in the form of a semi solid compound. According to the process of this invention low density polyethylene at a temperature of 110-160° C. is added to 5-50% ethylene vinyl acetate by weight of low density polyethylene is mixed therewith homogeneously. 0.25-10% rodent repellent material is added into said mixture. The mixture so obtained is subjected to the further step of mixing at the constant temperature and then shredded at room temperature in order to obtain a compound in the form of flakes. The flakes so obtained are subjected to conventional steps of film making.

### FIELD OF INVENTION

This invention relates to a rodent repellant composition and a process for the preparation thereof. Besides having applications for repelling rodents, the composition may also be advantageously employed for water/moisture proofing of storage rooms and packages.

### PRIOR ART

Rodent repellent composition based on low density polyethylene or LDPE are not as such known in the prior art.

### OBJECTS OF THE INVENTION

A primary object of this invention is to propose a rodent repellent composition having improved properties.

Another object of this invention is to propose rodent repellent composition having improved properties and a process for the preparation thereof.

### DESCRIPTION OF INVENTION

According to this invention there is provided a rodent repellant composition comprising 5-50% ethylene vinyl acetate by weight of low density polyethylene 0.25-10% rodent repellent material by weight of low polyethylene and the remainder being low density polyethylene mixed together in the form of a semi solid compound.

Further, according to this invention there is provided a process for the preparation of a rodent repellent composition comprising in adding low density polyethylene at a temperature of 110-160° C. to 5-50% ethylene vinyl acetate by weight of low density polyethylene therein and mixing the same homogeneously and then adding 0.25-10% rodent repellent material into said mixture, the mixture so obtained being subjected to the further step of mixing at the constant temperature and then shredded at room temperature in order to obtain a compound in the form of flakes which is subjected to conventional steps of film making.

In accordance with this invention the rodent repellant composition is prepared by adding low density polyethylene at a temperature of 110-160° C. in order to melt the low density polyethylene. 5-50% ethylene vinyl acetate by weight of low density polyethylene is added to said LDPE and is mixed to form a homogeneous mix 0.25-10% rodent repellent material by weight of low density polyethylene is added to said mixture and the mixture is subjected to the step of further mixing for a period of 5-10 minutes at a constant temperature. The mixture so obtained is shredded at room temperature so as to obtain rodent repellent compound in the form of flakes. The rodent repelleant material used are for example cycloheximide, tetramethyl thiuram disulphide, methyl anthranilate and zinc dimethyl dithiocarbamate. The compound so obtained is then subjected to the conventional steps of film making. The thickness of the film is in the range of 100-250 micron. The film so prepared is laminated onto a bitumen-jute laminate which is used as the rodent repellent material and also as moisture proofing and water proofing material.

The rodent repellent composition and a process for the preparation thereof is herein described in detail in the following examples:

### EXAMPLE NO.1

150 gms Low density polyethylene was taken into a mixer at a temperature of 115° C. so as to melt the low density polyethylene. 25 gms ethylene vinyl acetate was added into the mixture and a homogenous mix was prepared 3.5 gms methyl antranilate was added into said mixture. The mixture was subjected to the step of further mixing for a period of 5 minutes so as to obtain semisolid rodent repellant composition. The composition so obtained was shredded at room temperature to obtain the rodent repellant compound in the (powder) chips form. The rodent repellant compound obtained in the chips form was then subjected to the conventional steps of film making of the thickness of 150 micron. The film so obtained was then laminated on to a bitumen jute laminate for use as rodent as well as water/moisture proofing and it was found that the laminate does not work as rodent repellant material.

### EXAMPLE NO.2

100 gms of low density polyethylene was taken into a mixer at a temperature of 130° C. so as to melt the low density polyethylene. 15 gms ethylene vinyl acetate was added into the mixture and a homogeneous mix was prepared. 10 gms methyl anthranilite was added into said mixture and the mixture was subjected to the step of further mixing for a period of 8 minutes so as to obtain semi solid rodent repellent composition. The composition so obtain was shredded at room temperature to obtain the rodent repellent compound in the powder form. The rodent repellent compound obtain in the powder form was then subjected to the conventional steps of film making. The thickness of the film was kept 175 micron. The film so obtain was then laminated on to a bitumen jute laminates and it was found that the laminate does not work as rodent repellent material.

1. A rodent repellant composition comprising 5-50% ethylene vinyl acetate by weight of low density polyethylene, 0.25-10% rodent repellent material by weight of low density polyethylene and the remainder being low density polyethylene mixed together in the form of a semi solid compound.

2. A rodent repellant composition as claimed in claim 1 wherein rodent repellent material used are for example cycloheximide, tetramethyl thiuram disulphide, methyl anthranilate and zinc dimethyl dithiocarbamate.

3. A process for the preparation of a rodent repellent composition comprising in adding low density polyethylene at a temperature of 110-160° C. to 5-50% ethylene vinyl acetate by weight of low density polyethylene therein and mixing the same homogeneously and then adding 0.25-10% rodent repellent material into said mixture, the mixture so obtained being subjected to the further step of mixing at the constant temperature and then shredded at room temperature in order to obtain a compound in the form of flakes which is subjected to conventional steps of film making.

4. A process as claimed in claim 3 wherein the compound is subjected to the step of film making, and the film is then laminated.

5. A process as claimed in claim 3 wherein the thickness of the film is 100-250 micron.
